(19) United States
(12) Patent Application Publication
(10) Pub. No.: US 2022/0303658 A1
(43) Pub. Date: Sep. 22, 2022

(54) BONE-CONDUCTION HEADPHONE

(71) Applicant: DONGGUAN LUXSHARE PRECISION INDUSTRY CO. LTD., Dongguan City (CN)

(72) Inventors: Si CHEN, Dongguan City (CN); Lihong HE, Dongguan City (CN); Shaoming GAN, Dongguan City (CN)

(73) Assignee: DONGGUAN LUXSHARE PRECISION INDUSTRY CO. LTD., Dongguan City (CN)

(21) Appl. No.: 17/477,201

(22) Filed: Sep. 16, 2021

(30) Foreign Application Priority Data
Mar. 17, 2021 (CN) 202110287469.8

(51) Int. Cl. H04R 1/10; H04R 9/06; H04R 1/28

(52) U.S. Cl. CPC H04R 1/1016; H04R 9/06; H04R 1/2834; H04R 1/105; H04R 2460/13

(57) ABSTRACT

Provided is a bone-conduction headphone. The bone-conduction headphone includes a body, a bone bone-conduction loudspeaker and a passive radiator. The bone-conduction loudspeaker and the passive radiator are both installed in the body, and the bone-conduction loudspeaker and the passive radiator are disposed back-to-back and face opposite sides of the body, the passive radiator includes a diaphragm, the bone-conduction loudspeaker is connected to the diaphragm, and when the bone-conduction loudspeaker is excited by a sound source signal to vibrate, the diaphragm is driven to vibrate synchronously.

### CROSS-REFERENCE TO RELATED APPLICATION

This application claims priority to Chinese Patent Application No. 202110287469.8 filed Mar. 17, 2021, the disclosure of which is incorporated herein by reference in its entirety.

### TECHNICAL FIELD

The present disclosure relates to the technical field of headphones, in particular, to a bone-conduction headphone.

### BACKGROUND

Compared with ordinary headphones, a bone-conduction headphone transmits sound waves through the skull, the osseous labyrinth, the inner ear lymph fluid, the spiral organ, the auditory nerve and the auditory center of the human. Compared with the sound wave conduction mode of the ordinary headphones, when the bone-conduction headphone is used, many steps of the sound wave propagation are omitted, which can avoid the external interference and achieve the clear sound restoration in the noisy environment, and propagating of the sound wave in the air also does not affect other people.

However, the existing bone-conduction headphones, limited and influenced by factors such as technologies and wearing, usually use a single bone-conduction loudspeaker to achieve the sound transmission. With such design, the bone-conduction headphones have serious sound leakage and poor sound field effect, some of bands are defective, and especially, the bone-conduction headphones have apparent defects in the sense of texture and the sense of quantity of the low frequency, which influences the user experience.

### SUMMARY

The present disclosure provides a bone-conduction headphone with a dual vibration system, which can effectively increase the vibration quality, improve sound field radiation effect and improve the frequency response without increasing the power consumption.

To achieve this object, the present disclosure adopts the following technical solutions.

A bone-conduction headphone includes: a body, a bone-conduction loudspeaker, and a passive radiator. The bone-conduction loudspeaker is installed in the body. The passive radiator is installed in the body. The bone-conduction loudspeaker and the passive radiator are disposed back-to-back and face opposite sides of the body, the passive radiator includes a diaphragm, the bone-conduction loudspeaker is connected to the diaphragm, and when the bone-conduction loudspeaker is excited by a sound source signal to vibrate, the diaphragm is driven to vibrate synchronously.

In an embodiment, the bone-conduction loudspeaker includes a transducer and a vibration diaphragm. The transducer drives the vibration diaphragm to vibrate when the transducer is excited by a sound source signal, and the transducer is connected to the diaphragm.

In an embodiment, the transducer is connected to the diaphragm through a driving sleeve.

In an embodiment, the body is provided with a first accommodating groove, the vibration diaphragm is disposed in the first accommodating groove, the vibration diaphragm is covered with a first cover plate, a bottom of the first accommodating groove is provided with an active sound hole, the transducer passes through the active sound hole and is connected to the vibration diaphragm.

In an embodiment, an annular protrusion is protruded from an outer peripheral edge of the vibration diaphragm, an annular groove is disposed in the bottom of the first accommodating groove around the active sound hole, and the annular protrusion is engaged in the annular groove.

In an embodiment, a side of the annular protrusion facing the annular groove is serrated.

In an embodiment, the diaphragm includes a central area, an inner ring area and an outer ring area. The inner ring area is annularly arranged and connected to an outer periphery of the central area, and the outer ring area is annularly arranged and connected to an outer periphery of the inner ring area.

The passive radiator further includes a housing, the central area is connected to the bone-conduction loudspeaker, and the outer ring area is connected to the housing.

In an embodiment, the body is provided with a second accommodating groove, the second accommodating groove is provided with a second cover plate, and a bottom of the second accommodating groove is provided with a passive sound hole communicated with the housing.

In an embodiment, the housing and the body are integrally formed.

In an embodiment, the housing is a columnar structure, an end face of the columnar structure is provided with a first groove, the bottom of the first groove is provided with a second groove, the outer ring area is connected to the bottom of the first groove, and the passive sound hole is communicated with the bottom of the second groove.

### BRIEF DESCRIPTION OF DRAWINGS

FIG. 1 is a structure view of a bone-conduction headphone according to an embodiment of the present disclosure from a perspective;

FIG. 2 is a structure view of the bone-conduction headphone according to the embodiment of the present disclosure from another perspective;

FIG. 3 is a structure view illustrating that an outer cover is mated with a bone conduction loudspeaker, a passive radiator and a first cover plate according to an embodiment of the present disclosure;

FIG. 4 is a structure view illustrating that the outer cover is mated with the passive radiator according to an embodiment of the present disclosure;

FIG. 5 is a structure view illustrating that the outer cover is mated with a housing according to an embodiment of the present disclosure;

FIG. 6 is a structure view of a bone-conduction headphone according to an embodiment of the present disclosure from a perspective;

FIG. 7 is a structure view of the bone-conduction headphone according to the embodiment of the present disclosure from another perspective;

FIG. 8 is a structure view of a base according to an embodiment of the present disclosure;

FIG. 9 is a structure view of the base with a first cover plate removed according to an embodiment of the present disclosure;

FIG. 10 is a structure view of the base with the first cover plate and the bone-conduction loudspeaker removed according to an embodiment of the present disclosure;

FIG. 11 is a structure view of a base with a second cover plate removed according to an embodiment of the present disclosure;

FIG. 12 is a structure view illustrating that a hanger, a first pad and a second pad are mated with each other according to an embodiment of the present disclosure;

FIG. 13 is a structure view of the hanger according to an embodiment of the present disclosure;

FIG. 14 is a structure view of the first pad according to an embodiment of the present disclosure; and

FIG. 15 is a structure view of the second pad according to an embodiment of the present disclosure.

In the drawings:
1 body
11 base
111 inner housing
1110 first accommodating groove
1111 active sound hole
1112 annular groove
1113 charging end
112 outer cover
1120 second accommodating groove
1121 passive sound hole
1122 operation button
12 hanger
121 first arc section
122 second arc section
13 first pad
14 second pad
2 bone-conduction loudspeaker
21 transducer
22 vibration diaphragm
221 annular protrusion
23 driving sleeve
3 passive radiator
31 diaphragm
311 central area
312 inner ring area
313 outer ring area
32 housing
321 first groove
322 second groove
4 first cover plate
5 second cover plate
101 insertion groove
102 snap-fit hole
103 limiting groove
201 insertion pillar
202 snap-fit protrusion
203 limiting protrusion

### DETAILED DESCRIPTION

Embodiments in accordance with the present disclosure will now be described in detail below. Examples of the embodiments are illustrated in the drawings, where the same or similar reference numerals indicate the same or similar parts or parts having the same or similar functions. The embodiments described below with reference to the drawings are merely exemplary; they are intended to explain the present disclosure, and are not to be construed as limiting the present disclosure.

In the description of embodiments of the present disclosure, unless otherwise expressly specified and limited, the term “connected to each other”, “connected” or “fixed” is to be construed in a broad sense, for example, as fixedly connected, detachably connected, mechanically connected or electrically connected, directly connected to each other or indirectly connected to each other via an intermediary, or internally connected or interactional between two components. For those of ordinary skill in the art, the above terms can be construed according to specific circumstances in the present disclosure.

In the description of the present disclosure, unless otherwise expressly specified and limited, when a first feature is described as “on” or “below” a second feature, the first feature and the second feature may be in direct contact, or be in contact via another feature between the two features instead of being in direct contact. Moreover, when the first feature is described as “on”, “above” or “over” the second feature, the first feature is right on or obliquely on the second feature, or the first feature is simply at a horizontally higher level than the second feature. When the first feature is described as “under”, “below” or “underneath” the second feature, the first feature is right under, below or underneath the second feature or the first feature is obliquely under, below or underneath the second feature, or the first feature is simply at a lower level than the second feature.

In the existing art, the passive radiator is usually used in stereo equipment, and the stereo equipment using the passive radiator typically includes one active loudspeaker unit and one passive unit (i.e., a passive radiator). The passive unit is generally similar in appearance to the active loudspeaker unit, but has no voice coil and driving magnet. The active unit in the stereo equipment passively sounds under the driving of the air in the box to adjust the sound quality of a smaller box, so that the stereo equipment may have a better bass performance.

The technical solutions of the present disclosure will be further described below through specific embodiments in conjunction with the drawings.

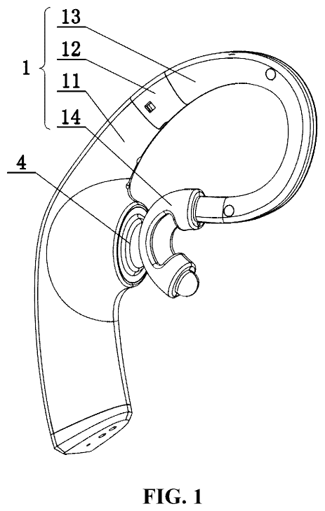

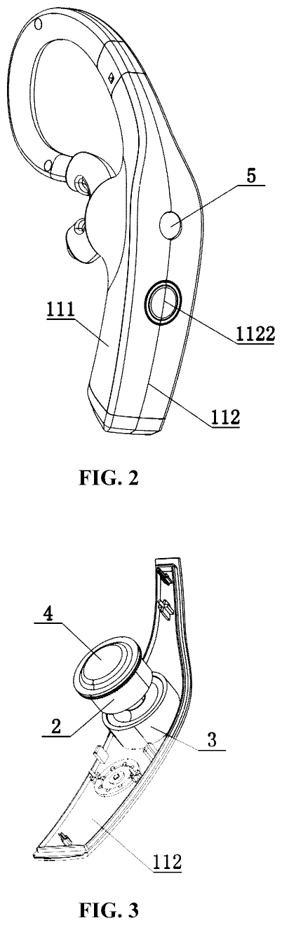

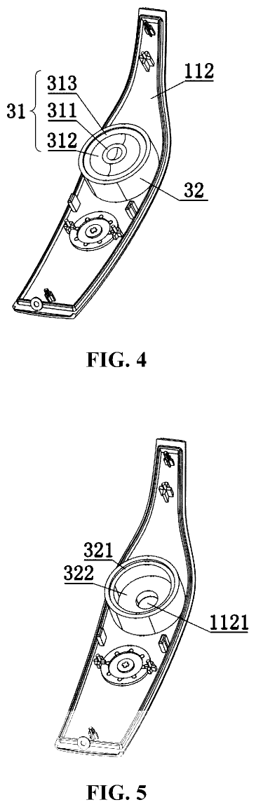

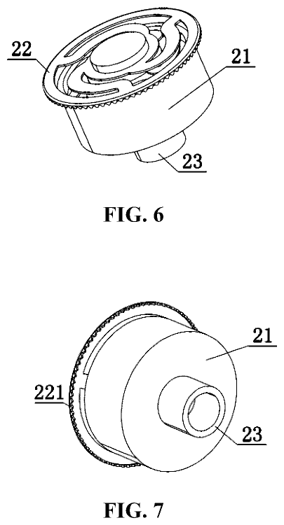

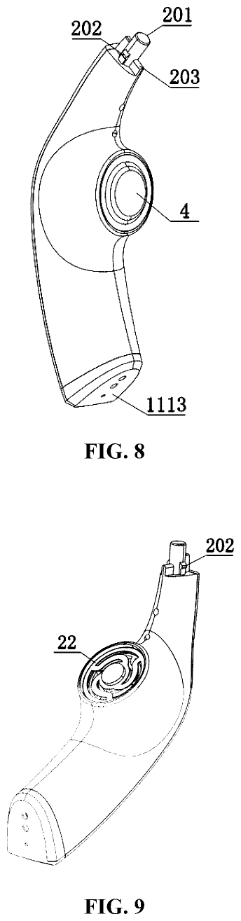

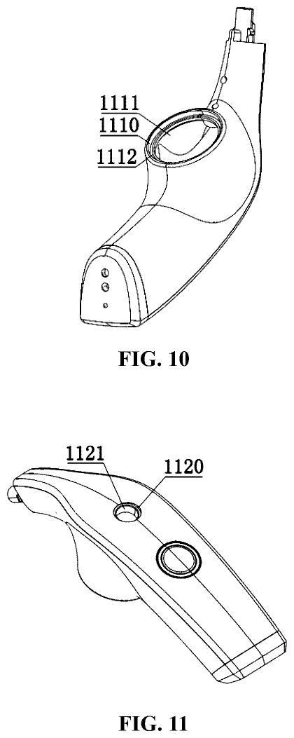

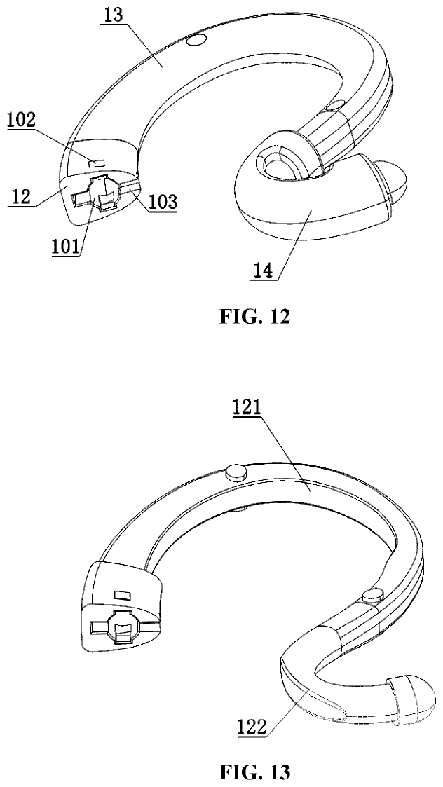

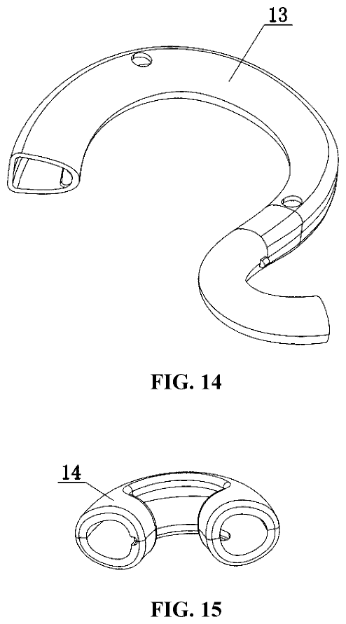

As shown in FIGS. 1 to 15, the present disclosure provides a bone-conduction headphone. The bone-conduction headphone includes a body 1, a bone-conduction loudspeaker 2 and a passive radiator 3. Both the bone-conduction loudspeaker 2 and the passive radiator 3 are installed in the body 1, and the bone-conduction loudspeaker 2 and the passive radiator 3 are disposed back-to-back and face opposite sides of the body 1, the passive radiator 3 includes a diaphragm 31, the bone-conduction loudspeaker 2 is connected to the diaphragm 31, and when the bone-conduction loudspeaker 2 is excited by a sound source signal to vibrate, the diaphragm 31 is driven to vibrate synchronously.

In the present disclosure, based on the bone-conduction loudspeaker 2, the passive radiator 3 is provided, and the diaphragm 31 of the passive radiator 3 is connected to the bone-conduction loudspeaker 2 to form a dual vibration system, so that the passive radiator 3 and the bone-conduction loudspeaker 2 can vibrate synchronously, thereby improving the amplitude-frequency response, increasing the effective vibration quality, improving the sound field radiation effect, effectively ensuring the consistent phase response, and improving the frequency response, especially for the problem of insufficient frequency response. In addition, the vibration of the passive radiator 3 is powered by the bone-conduction loudspeaker 2, and thus, no additional power consumption is required.

In an embodiment, the bone-conduction loudspeaker 2 includes a transducer 21 and a vibration diaphragm 22. The transducer 21 drives the vibration diaphragm 22 to vibrate when excited by the sound source signal. The transducer 21 is connected to the diaphragm 31 so that the diaphragm 31 can be excited more directly. The transducer 21 and the vibration diaphragm 22 are conventional components in the art, and the specific structure and operation principle thereof will not be described here.

In an embodiment, the transducer 21 is connected to the diaphragm 3 through a driving sleeve 23. With the driving sleeve 23, the position setting of the transducer 21 and the diaphragm 31 is more flexible, and a driving member in a shape of a sleeve has less interference to the diaphragm 31 while ensuring the driving effect.

In an embodiment, the body 1 is provided with a first accommodating groove 1110, the vibration diaphragm 22 is disposed in the first accommodating groove 1110, the vibration diaphragm 22 is covered with a first cover plate 4, a bottom of the first accommodating groove 1110 is provided with an active sound hole 1111, and the transducer 21 passes through the active sound hole 1111 and is connected to the vibration diaphragm 22. The first receiving groove 1110 is mated with the active sound hole 1111, so that the sound energy of the bone-conduction loudspeaker 2 can be more smoothly exported, and the first cover plate 4 is configured to be in contact with the human body, thereby improving the use experience.

In an embodiment, an annular protrusion 221 is protruded from an outer peripheral edge of the vibration diaphragm 22, an annular groove 1112 is disposed in the bottom of the first accommodating groove 1110 surrounding the active sound hole 1111, and the annular protrusion 221 is engaged in the annular groove 1112. The annular protrusion 221 is mated with the annular groove 1112 so that the vibration diaphragm 22 can be more reliably placed in the first accommodating groove 1110.

In this embodiment, a side of the annular protrusion 221 facing the annular groove 1112 is serrated. The arrangement of the serrated structure increases a friction force between the annular protrusion 221 and the annular groove 1112, and improves the reliability and stability of the assembly.

In an embodiment, the diaphragm 31 includes a central area 311, an inner ring area 312 and an outer ring area 313. The inner ring area 312 is annularly arranged and connected to an outer periphery of the central area 311, and the outer ring area 313 is annularly arranged and connected to an outer periphery of the inner ring area 312. The passive radiator 3 further includes a housing 32, the central area 311 is connected to the bone-conduction loudspeaker 2, and the outer ring area 313 is connected to the housing 32. With the arrangement of the above specific structure of the diaphragm 31, the fixed installation is more secure, and the linkage effect with the bone-conduction loudspeaker 2 is better.

In an embodiment, the body 1 is provided with a second accommodating groove 1120, the second accommodating groove 1120 is provided with a second cover plate 5, and a bottom of the second accommodating groove 1120 is provided with a passive sound hole 1121 communicated with the housing 32. The second accommodating groove 1120 is configured to be mated with the passive sound hole 1121 so that the sound energy of the passive radiator 3 can be more smoothly exported, and the arrangement of the second cover plate 5 plays a role of sealing and dustproof.

In this embodiment, the housing 32 and the body 1 are integrally formed, so that the preparation is simpler and the assembly is more convenient.

In an embodiment, the housing 32 is a columnar structure, an end face of the columnar structure is provided with a first groove 321, the bottom of the first groove 321 is provided with a second groove 322, the outer ring area 313 is connected to the bottom of the first groove 321, and the passive sound hole 1121 is communicated with the bottom of the second groove 322. With the above arrangement, the acoustic energy generated by the vibration of the diaphragm 31 can be directly exported by the passive sound hole 1121 through the second cover plate 5.

In an embodiment, the body 1 includes a base 11 and a hanger 12. The bone-conduction loudspeaker 2 and the passive radiator 3 are installed on the base 11 separately. The hanger 12 is detachably connected to the base 11, and can be hooked to an outer periphery of the human ear, specifically, to an outer periphery of the auricle, and the hanger 12 cooperates with the bone-conduction loudspeaker 2 to clamp the human ear, specifically, the cartilage on the auricle. The above arrangement facilities the replacement of the hanger 12 of different sizes and specifications according to the user's usage habits and comfort.

In an embodiment, one of the hanger 12 and the base 11 is provided with an insertion groove 101 and snap-fit holes 102 penetrating side walls of the insertion groove 101, and the other of the hanger 12 and the base 11 is provided with an insertion column 201 and snap-fit protrusions 202 connected to an outer wall of the insertion column 201. The insertion column 201 is inserted in the insertion groove 101, and the snap-fit protrusions 202 are snap fit into the snap-fit holes 102. With the above arrangement, the hanger 12 and the base 11 are more securely and reliably connected while the disassembly is facilitated.

In this embodiment, the insertion column 201 and the snap-fit protrusions 202 connected to the outer wall of the insertion column 201 are disposed on the base 11. Two snap-fit protrusions 202 are provided, and are disposed on two opposite sides of the insertion column 201. The insertion groove 101 and the snap-fit holes 102 penetrating side walls of the insertion groove 101 are provided on the hanger 12. Two snap-fit holes 102 are provided, and are disposed on two opposite sides of the insertion groove 101.

In an embodiment, a limiting groove 103 penetrating the side walls is further provided at a notch of the insertion groove 101, and a limiting protrusion 203 is connected to the outer wall of the insertion column 201, and the limiting protrusion 203 is engaged in the limiting groove 103. With the above arrangement, a fool-proof effect is achieved, avoiding that the hanger 12 and the base 11 are connected in opposite orientations.

In an embodiment, the base 11 includes an inner housing 111 and an outer cover 112, an opening of the inner housing 111 is disposed facing away from the hanger 12, the active sound hole 1111 is disposed on the inner housing 111, the passive sound hole 1121 is disposed on the outer cover 112, the bone-conduction loudspeaker 2 is installed directly facing the active sound hole 1111, and the passive radiator 3 is installed directly facing the passive sound hole 1121.

In this embodiment, the insertion column 201, the snap-fit protrusions 202 and the limiting protrusion 203 are all disposed at one end of the inner housing 111, and the other end of the inner housing 111 is also provided with a charging end 1113 through which external equipment may charge a power supply in the inner housing 111. An outer side of the outer cover 112 is also provided with an operation button 1122 which is electrically connected to a circuit board in the inner housing 111 and can control the power on and power off of the bone-conduction headphone.

In an embodiment, the hanger 12 is rod-shaped, and includes a first arc section 121 and a second arc section 122 which are connected to each other. A free end of the first arc section 121 is connected to the base 11, the first arc section 121 is bent facing the base 11 and is able to be hooked on the outer periphery of the human ear. The second arc section 122 is bent away from the base 11 and an outer surface of the second arc section 122 abuts against the first cover plate 4. When the bone-conduction headphone is worn by the user, the first arc section 121 is hooked on the outer periphery of the ear, and the second arc section 122 cooperates with the first cover plate 4 to clamp the cartilage on a rear side of the ear, so that the wearing the bone-conduction headphone is worn more securely and not easy to drop during the use.

In an embodiment, the body 1 further includes a first pad 13. The first pad 13 is sleeved outside the first arc section 121, and the first arc section 121 is hooked to the outer periphery of the human ear through the first pad 13. The first pad 13 is made of a soft material such as rubber, and with the arrangement of the first pad 13, it is more comfortable for the user to wear.

In this embodiment, the first arc section 121 is provided with bumps, and the first pad 13 is provided with through holes. When the first pad 13 is sleeved on the first arc section 121, the bumps penetrates through the through holes and are flush with outer ports of the through holes. With the above arrangement, the movement and displacement of the first pad 13 is avoided which the first pad 13 is ensured to be detachable, thereby increasing the comfort.

In an embodiment, the body 1 further includes a second pad 14. The second pad 14 is sleeved on the second arc section 122, and an outer surface of the second arc section 122 abuts against the first cover plate 4 through the second pad 14.

In this embodiment, the second pad 14 is also made of a soft material such as the rubber, and with the arrangement of the second pad 14, it is more comfortable for the user to wear.

Apparently, the above embodiments of the present disclosure are merely illustrative of the present disclosure and are not intended to limit the embodiments of the present disclosure. For those of ordinary skill in the art, alterations or modifications in other different forms can be made based on the above description. Embodiments of the present disclosure cannot be and do not need to be exhausted herein. Any modifications, equivalent substitutions and improvements within the spirit and principle of the present disclosure fall within the scope of the claims of the present disclosure.

What is claimed is:

1. A bon-conduction headphone, comprising:
a body;
a bone-conduction loudspeaker, which is installed in the body;
a passive radiator, which is installed in the body, wherein the bone-conduction loudspeaker and the passive radiator are disposed back-to-back and face opposite sides of the body, the passive radiator comprises a diaphragm, the bone-conduction loudspeaker is connected to the diaphragm, and when the bone-conduction loudspeaker is excited by a sound source signal to vibrate, the diaphragm is driven to vibrate synchronously.

2. The bone-conduction headphone of claim 1, wherein the bone-conduction loudspeaker comprises a transducer and a vibration diaphragm, wherein the transducer drives the vibration diaphragm to vibrate when the transducer is excited by a sound source signal, and the transducer is connected to the diaphragm.

3. The bone-conduction headphone of claim 2, wherein the transducer is connected to the diaphragm through a driving sleeve.

4. The bone-conduction headphone of claim 2, wherein the body is provided with a first accommodating groove, the vibration diaphragm is disposed in the first accommodating groove, the vibration diaphragm is covered with a first cover plate, a bottom of the first accommodating groove is provided with an active sound hole, the transducer passes through the active sound hole and is connected to the vibration diaphragm.

5. The bone-conduction headphone of claim 4, wherein an annular protrusion is protruded from an outer peripheral edge of the vibration diaphragm, an annular groove is disposed in the bottom of the first accommodating groove around the active sound hole, and the annular protrusion is engaged in the annular groove.

6. The bone-conduction headphone of claim 5, wherein a side of the annular protrusion facing the annular groove is serrated.

7. The bone-conduction headphone of claim 1, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.

8. The bone-conduction headphone of claim 7, wherein the body is provided with a second accommodating groove, the second accommodating groove is provided with a second cover plate, and a bottom of the second accommodating groove is provided with a passive sound hole communicated with the housing.

9. The bone-conduction headphone of claim 8, wherein the housing and the body are integrally formed.

10. The bone-conduction headphone of claim 9, wherein the housing is a columnar structure, an end face of the columnar structure is provided with a first groove, the bottom of the first groove is provided with a second groove, the outer ring area is connected to the bottom of the first groove, and the passive sound hole is communicated with the bottom of the second groove.

11. The bone-conduction headphone of claim 2, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.

12. The bone-conduction headphone of claim 3, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.

13. The bone-conduction headphone of claim 4, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.

14. The bone-conduction headphone of claim 5, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.

15. The bone-conduction headphone of claim 6, wherein the diaphragm comprises a central area, an inner ring area and an outer ring area, wherein the inner ring area is annularly arranged and connected to an outer periphery of the central area, and the outer ring area is annularly arranged and connected to an outer periphery of the inner ring area; and
the passive radiator further comprises a housing, the central area is connected to the bone-conduction loudspeaker, and the outer ring area is connected to the housing.
